(19) United States
(12) Patent Application Publication
(10) Pub. No.: US 2017/0356574 A1
(43) Pub. Date: Dec. 14, 2017

(54) THREADED INSERT FOR CONNECTIONS OF TUBES AND ACCESSORIES FOR LIQUID AND GASEOUS FLUIDS IN GENERAL

(71) Applicants: Ramiro Gabriel OLMEDO, Prov. de Buenos Aires (AR); Juan Pablo PESCULICH, Ciudad Autonoma de Buenos Aires (AR); Alejandro DE LUQUE, Ciudad Autonoma de Buenos Aires (AR)

(72) Inventors: Ramiro Gabriel OLMEDO, Prov. de Buenos Aires (AR); Juan Pablo PESCULICH, Ciudad Autonoma de Buenos Aires (AR); Alejandro DE LUQUE, Ciudad Autonoma de Buenos Aires (AR)

(21) Appl. No.: 15/181,459

(22) Filed: Jun. 14, 2016

(51) Int. Cl. F16L 15/08

(52) U.S. Cl. CPC F16L 15/08

(57) ABSTRACT

The present invention relates to a threaded insert for the connection of tubes and accessories, such as fittings for liquid and gaseous fluids in general, directed to the tube male/female connections of the type that are connected together from one of its ends by thermo fusion, cold welding, with rubber ring, among other possible forms of connection, that prevent the leakage through the male/female connection of the pieces. That includes a tubular metallic body, which includes a first male segment tightly coupled to the end of a pipe or the fitting, and a second male segment including an outer coating of elastomeric material which defines a thread sealant between the parts to be connected. The first male segment includes a cross-section larger than the diameter of the second male segment, thus forming a step between both segments. Preferably, the elastomeric material is PTFE (polytetrafluoroethylene), even though in practice can also use other materials that perform the sealing function efficiently.

### FIELD OF THE INVENTION

The present invention relates to a threaded insert for connections of tubes and conduction accessories of liquid and gaseous fluids in general, and more particularly, for a metallic insert that can be incorporated to tubes and/or accessories of the type bound by thermo fusion, cold welding, with rubber ring, among other possible forms of union, allowing this insert to ensure the sealed and air-tightness of the corresponding connections.

### BACKGROUND OF THE INVENTION

One of the main conditions or properties that the fluid conduction tubes must comply lies in the tightness of the connections between the ends of successive tubes as well as between the tubes and the corresponding installation accessories, to prevent the risk of leakage or loss of fluids. Although the tightness of joints is a condition required in all types of tube fittings for conveyance of fluids, acquired a fundamental importance when to fluids are, for example, flammable and/or toxic, both liquids as gaseous, since in case of the leakage of the fluids, in addition to the technical problems that this situation causes, they are at risk of accidents of different consideration by combustion of the fluid and/or poisoning of the people in the vicinity of the leak or in the environment where it has occurred. The disadvantages of the fluid leakage, and in particular the repair work of the defective joints, are even higher when the tubes are embedded in walls and in masonry in general, since in certain cases it is usually difficult to precisely locate the point where the leak occurs and, as a result, part of the material covering the pipes need to be broken to locate and repair the faulty union.

In the prior art, in this field, there are known different systems and methods of sealing of the joints of tubes and fittings, for joints between ends of connection that are threaded and non-threaded. In both cases, when the tubes and accessories are made of polymeric material or the combination of polymeric and metallic bodies, the safer and more frequent connections are those carried out by thermo fusion of the thermoplastic material. However, while union by thermo fusion procedures are generally efficient, when the connection between the tubes and the accessories is made in first instance by means of at least one metallic thread, i.e., for example, a male metal thread and a female thread made of the thermo fusion polymeric material, is convenient to complete the union by means of a seal that ensures its tightness and, therefore, reduce as much as possible the risks of leakage of the fluid. Therefore, have developed different ways of sealing the joints.

The prior art shows a process for the application of a coating of a fluoropolymer in a threaded connection and, in particular, to all of the threads of the connection. The fluoropolymer is supplied in powder form to a spray nozzle from which is discharged at room temperature on the selected area of the connection, and then is heated to a temperature above the melting point of the fluoropolymer to melt the powder and form a coating of continuous film that when it cools, adheres to the area of the connection.

In addition, the prior art shows a seal for threaded connections in pipes made with external thread united by couplings having internal thread, which is made of a cylindrical sleeve of elastomeric material, being this seal preferably used in aggressive fluids pipes, hydrocarbons, and their derivatives, and the like.

Furthermore, the prior art shows a sealed connection of high-strength for radially expandable tubes to be used in oil and gas wells, which has a pair of tubular elements with a thread in a free end and couple together to form the connection, and a sealing substance applied on both elements, which after radially expanding, keeps the sealing substance adhered between the threads of the same.

The joints and sealing forms according to the above identified prior art are typical examples of the state of the art, it is worth mentioning that, these connections as well as other existing, in general have been developed especially for specific applications where the tubes must comply with strict regulations and safety industrial controls, such as it is required in the field of hydrocarbons extractions and other facilities that operate under certain conditions which require in extremely the structure of tubes and especially, the corresponding unions. It is to say, that such connections are not meant to be used in facilities for general use where the security demands, while they must comply fully with the regulations on the field, are less stringent since the tubes are not subjected to critical condition. On the other hand, it is convenient to have joints for tubes that, even if they are formed by simple structures, allow fast and secure connections and, in addition, whose manufacture cost and sale price are considerably under in respect to the connections as mentioned above.

### SUMMARY OF THE INVENTION

It is the object of the present invention to provide a threaded insert for the connection of tubes and accessories such as fittings for liquid and gaseous fluids in general, directed to the tube male/female connections of the type that are connected together from one of its ends by thermo fusion, cold welding, with rubber ring, among other possible forms of connection, that prevent the leakage through the male/female connection of the pieces. That includes a tubular metallic body, which includes a first male segment tightly coupled to the end of a pipe or the fitting, and a second male segment including an outer coating of elastomeric material which defines a thread sealant between the parts to be connected. The first male segment includes a cross-section larger than the diameter of the second male segment, thus forming a step between both segments. Preferably, the elastomeric material is PTFE (polytetrafluoroethylene), even though in practice can also use other materials that perform the sealing function efficiently.

### BRIEF DESCRIPTION OF DRAWINGS

For greater clarity and understanding of the object of the present invention, it has illustrated in several figures that represent it in one of the preferred ways of preparation, all for example, where:

FIG. 1 is a perspective view of the insert according to an embodiment of the present invention;

FIGS. 2A and 2B are cross sectional views of the insert of FIG. 1 showing two possible forms of implementation; and

FIG. 3 is a perspective view of the insert of FIG. 1 showing the insert having an elbow shape.

### DETAILED DESCRIPTION OF THE INVENTION

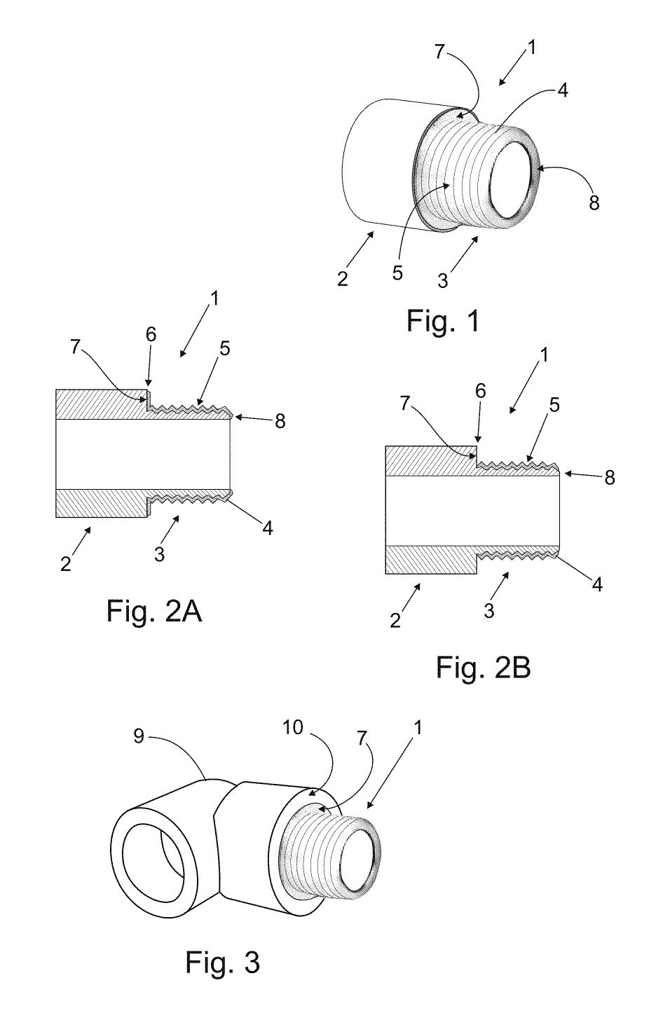

FIGS. 1 and 2 show the insert 1 of the present invention having a tubular body that includes a first male segment 2 from which tightly fits to the end of a tube (pipe) or a fitting, and a second male segment 3 coated by a layer of an elastomeric polymer 4 which includes an external thread 5. This polymeric layer 4 defines the element that seals the union between the pieces to be connected.

The first male segment 2 insert has a diameter larger than the diameter of the second male segment 3, forming in this way an annular step 6 having a front face 7 that, once placed the insert in the tube or the fitting, is aligned with the plane of the front wall of the end of the tube or corresponding accessory. Preferably, the polymer layer 4 extends covering the front face 7 of said step 6 and the front face 8 of the segment 3 of the insert 1.

Example of application of FIG. 3, which shows the insert 1 placed in a connecting accessory 9, where it can clearly see the union among the front face 7 of the step 6, formed by the difference of diameters from the first male segment 2 and the second male segment 3 of the insert 1, and the front face 10 of the tubular section of the accessories 9 in which the insert is placed.

In practice, the elastomeric polymer used for the layer 4 is thermoplastic, and preferably PTFE (polytetrafluoroethylene) that includes various properties appropriate to the purpose of the insert for being practicable, almost inert, does not react with other chemical substances except in very special situations, has very low friction coefficient and great impermeability, is an electrical insulator, extremely flexible, is not altered by the action of the light, and is resistant to extreme temperatures. In addition, it is prevented the possibility of forming a polymer coating as a painting bath that will reach a sufficient thickness to ensure its sealing function of the connections. In addition, the sealing element defined by the layer 4 can be a coverage that later may require a curing, as also an electrolytic bath, or treatment of similar characteristics. Irrespective of the material used, the layer 4 can cover partially or totally the insert 1.

Meanwhile, in an embodiment, the main body of the insert, i.e. the first male segment 2 and the second segment 3 without the layer 4, are formed by a single metal piece, and the material to use may be, for example, brass, copper, iron, stainless steel, among other possibilities.

Having thus particularly described and given the nature of the present invention and form as it has to be realized, what is claimed is:

1. A threaded insert for connecting tubes and fittings for liquid and gaseous fluids comprising:
a tubular body including:
a first male segment adapted to be tightly coupled to an end of a pipe or a fitting;
a second male segment having a coating made of an elastomeric material including threads.

2. The insert according to claim 1, wherein the elastomeric material is polytetrafluoroethylene.

3. The insert according to claim 1, wherein the elastomeric material is thermoplastic material.

4. The insert according to claim 2, wherein the elastomeric material coating is arranged in the form bands wounded along the second male segment of the tubular body.

5. The insert according to claim 1, wherein the elastomeric material is applied to the second male segment as a paint bath.

6. The insert according to claim 1, wherein the first male segment and the second segment of the insert are shaped by a single metal piece.

7. The insert according to claim 6, wherein the metal piece is made of brass, copper, iron, stainless steel, or zinc.

8. The insert according to claim 1, wherein the first male segment has a diameter larger than a diameter of the second segment forming a step.

9. The insert according to claim 1, wherein the elastomeric material extends over the step.
